(19) United States
(12) Patent Application Publication
(10) Pub. No.: US 2004/0025770 A1
(43) Pub. Date: Feb. 12, 2004

(54) Method and apparatus for retrieving game from a water surface

(76) Inventors: Ronald F. Saunoris, Elk Grove Village, IL (US); Larry D. Hodson, Park Forest, IL (US)

Correspondence Address: MERONI + MERONI, P.O. BOX 309, BARRINGTON, IL, 60011, US

(21) Appl. No.: 10/214,861

(22) Filed: Aug. 8, 2002

(51) Int. Cl. B63B 35/08; A01M 31/06

(52) U.S. Cl. 114/144 A; 114/40; 43/3

(57) ABSTRACT

The present invention provides a remotely controlled, water-borne vessel to retrieve floating game on a given body of water, which water-borne vessel is sized, shaped and marked to resemble a waterfowl so as to encourage or attract game birds or waterfowl to the operating site of the water-borne vessel. The water-borne vessel, thus configured is further outfitted with either a grappling structure or ice-breaking member for retrieving or removing downed, floating waterfowl or other surface matter from a body of water. A user may thus propel the outfitted water-borne vessel into adjacency with downed, floating waterfowl, grapple the downed, floating waterfowl and steerably propel the grappled waterfowl to a recipient for retrieving the downed waterfowl. Alternatively, the user may steerably propel the water-borne vessel through skim ice for removing the skim ice or other surface matter from the water surface for alluring waterfowl to the resultant ice-free water surface.

### BACKGROUND OF THE INVENTION

1. Field of the Invention

The present invention relates to a waterfowl decoy apparatus for retrieving downed game birds from water surfaces. More specifically, the present invention is primarily intended as a downed game bird retrieving apparatus, which is sized, shaped and marked to resemble a waterfowl. The present invention thus serves to allure game birds to a body of water rather than scarecrow or frighten away game birds while retrieving downed game birds from a water surface. Further, the present invention may be outfitted to break skim ice formed on water surfaces and maintain an ice-free water surface so as to further allure game birds to the body of water rather than scarecrow game birds while breaking skim ice on the water surface.

2. Description of the Prior Art

Decoy art is old having its origins in primitive hunter societies. Hunter societies on the American Continent, for example, have used decoys in their hunt for centuries. Of these primitive decoys, some were designed, in part, to bring game birds or other species of game within close proximity to the hunters due to the relatively primitive weaponry of the day. In this regard, it is noted that bird decoys estimated to be over a thousand years old, and simplistically made of reeds and feathers have been discovered, many of which have been preserved from these earlier times. Down through the centuries, hunters have continually endeavored to improve upon their decoys and the process of continual improvement persists to this day.

Despite the trend to constantly improve upon that which has come before, it is well known in the art that waterfowl decoys, in particular, can be very simple and yet allure waterfowl. For example, it is noted that effective waterfowl decoys can be made from mud lumps, newspapers, bottles, diapers and even rags. Conversely, complex decoys are also effective. Remotely controlled, robotic decoys, for example, lure not only other game, but human poachers as well. The more lifelike the decoy, it is argued, the more effective the decoy for alluring game.

In the early 1900's, hunters commonly used trained live game birds to lure wild game birds. The use of these live so-called decoys, however, was outlawed in the United States in 1935, prompting hunters in the United States to find life-like substitutes. Decoy dogma teaches that visually imitative decoys tend to be more effective at luring wildlife. When used with an eye toward wildlife population sustainability, visually imitative decoys enable the user to reach a hunt limit more efficiently, thus leaving far fewer wounded animals in the environment. Similarly, visually imitative decoys enable users to lure wildlife away from environmental locations where its presence is undesirable. It is therefore noted that visually imitative decoys employing motorized systems for animation are among the most effective decoys available.

Hunters, in an effort to retrieve game or waterfowl downed in a typical hunt have coupled retrieval systems into the general hunting scheme. In this regard, it has been common practice to utilize the services of trained canine retrievers to retrieve downed game and the like. However, retrieval systems such as the use of waterfowl-frightening canines have not always been the ideal retrieval means since waterfowl and other species of game tend to shy away from the presence of non-alluring retrieval systems such as a trained canine and the like. Furthermore, waterfowl and other similar game tend to shy away from hunting scenarios in which the hunter utilizes mechanical retrieval means for retrieving downed waterfowl and/or other similar game. The prior art does disclose mechanical waterfowl retrieval apparatuses or devices of this type, some of which are described hereinafter.

U.S. Pat. No. 2,857,702 ('702 Patent), which issued to Erdman, discloses a Water Game Retriever. The Water Game Retriever comprises a generally U-shaped flotation device having a rear central portion and a pair of laterally spaced side portions. The side portions each extend in a forward manner and define an opening or mouth at the forward end for receiving game or other floating articles. The rear central portion is adapted to increase its lateral dimension for receiving floating matter having larger lateral dimensions. A reel line is centrally attached to the forward end of each of two bowlines. The bowlines then each attach in an aft manner to a respective side portion. In operation, the Water Game Retriever is cast underhand beyond the floating game or floating matter to be retrieved and then reeled in so that the floating game or floating matter passes under the bowlines and enters the mouth of the retriever until drawn or reeled ashore.

It will be seen that the Water Game Retriever does not teach the use of a remotely controlled, water-borne vessel to retrieve floating game or other floating matter on a given body of water. Further, the Water Game Retriever does not teach the use of a remotely controlled, water-borne device to retrieve floating game or other floating matter, which device is sized, shaped and marked to resemble a waterfowl. The Water Game Retriever thus does not teach the use of a waterfowl decoy, which can be simultaneously utilized to allure or attract waterfowl, in the first instance, and retrieve floating game or other matter, in the second instance. Further, the Water Game Retriever does not disclose a method or decoy apparatus for simultaneously alluring waterfowl, retrieving floating matter and breaking skim ice for maintaining an ice-free surface on a given body of water. It is well known that ice-free water surfaces are more conducive for alluring waterfowl or other game birds to a given body of water. In this regard, the Water Game Retriever, while perhaps effective at maintaining an ice-free water surface by repeated launches into a given body of water, the same launching technique would tend to discourage game birds or waterfowl from landing in the ice-free water surface.

U.S. Pat. No. 3,026,545 ('545 Patent), which issued to Brainard, discloses a Retrieving Vessel and Launcher Therefor. The Retrieving Vessel and Launcher Therefor is essentially a remotely controlled vessel for retrieving floating matter (particularly downed game birds) on the surface of a given body of water and generally comprises a hull, a deck sealing the hull, driving means for propelling the vessel, rudder means for steering the vessel, a radio receiver carried in the hull, apparatus for receiving radio signals for controlling the driving and rudder means, and a plurality of arms affixed to the hull for receiving and retaining floating matter against the bow of the vessel while the vessel is moving in a forward direction until drawn ashore or until drawn to rescuers. In this last regard, it is further contemplated that a larger scale vessel may be utilized in life-saving situations, namely, for retrieving persons or other living creatures in distress in a given body of water.

It will thus be seen that the Retrieving Vessel and Launcher Therefor does not teach the use of a remotely controlled, water-borne vessel to retrieve floating game or other floating matter on a given body of water, which water-borne vessel is sized, shaped and marked to resemble a waterfowl. The Retrieving Vessel and Launcher Therefor thus does not teach the use of a waterfowl decoy, which can be simultaneously utilized to attract or allure waterfowl, in the first instance, and retrieve floating game or other matter, in the second instance. Further, the Retrieving Vessel and Launcher Therefor does not disclose a method or decoy apparatus for simultaneously alluring waterfowl, retrieving floating matter and breaking skim ice for maintaining an ice-free surface on a given body of water. As stated, it is well known that ice-free water surfaces are more conducive for alluring waterfowl or other game birds to the given body of water. In this regard, the Retrieving Vessel and Launcher Therefor, while perhaps effective at maintaining an ice-free water surface by continuously maneuvering through and disturbing the surface of a given body of water, is much less effective at alluring game birds or other waterfowl, insofar as the Retrieving Vessel and Launcher Therefor is not sized, shaped or marked to resemble a waterfowl. The Retrieving Vessel and Launcher Therefor thus also tends to discourage game birds or waterfowl from landing in ice-free water surfaces in which it is operable.

U.S. Pat. No. 4,545,315 ('315 Patent), which issued to Becherer, discloses a Remote Control Water Fowl Retrieving Device. The Remote Control Water Fowl Retrieving Device comprises a housing portion, which includes a pair of extend forwardlying spaced-apart pontoon members, a forwardly projecting scoop pivotally mounted on the housing member and extending forwardly therefrom between the pontoon members, movable between a raised position and a lowered position. Further, the Remote Control Water Fowl Retrieving Device comprises propulsion means, steering means, a radio receiver device and associated control circuits, which include a source of energy located in the housing portion. The control circuits further include mechanisms for controlling the energizing and the direction of energizing of the scoop drive circuit, the propulsion means, and the steering means under control of signals received from the radio receiver device.

It is noted that the Remote Control Water Fowl Retrieving Device does not teach a remotely controlled, water-borne vessel to retrieve floating game or other floating matter on a given body of water, which water-borne vessel is sized, shaped and marked to resemble a waterfowl. The Remote Control Water Fowl Retrieving Device thus does not teach the use of a waterfowl decoy, which can be simultaneously utilized to attract or allure waterfowl, in the first instance, and retrieve floating game or other matter, in the second instance. Further, the Remote Control Water Fowl Retrieving Device does not disclose a method or decoy apparatus for simultaneously alluring waterfowl, retrieving floating matter and breaking skim ice for maintaining an ice-free surface on a given body of water. As stated, it is well known that ice-free water surfaces are more conducive for alluring waterfowl or other game birds to the given body of water. In this regard, the Remote Control Water Fowl Retrieving Device, while perhaps effective at maintaining an ice-free water surface by continuously maneuvering through and disturbing the surface of a given body of water, is less effective at alluring game birds or other waterfowl, insofar as the Remote Control Water Fowl Retrieving Device is not sized, shaped or marked to resemble a waterfowl. The Remote Control Water Fowl Retrieving Device thus also tends to discourage game birds or waterfowl from landing in ice-free water surfaces in which it is operable.

The prior art thus perceives a need for a remotely controlled, water-borne vessel to retrieve downed, floating waterfowl, game or other floating matter on a given body of water, which water-borne vessel is sized, shaped and marked to resemble a waterfowl so as to encourage or allure game birds or waterfowl to the site of the water-borne vessel, namely the body of water into which the water-borne vessel is placed. Further, the prior art perceives a need for a remotely controlled waterfowl decoy apparatus or other game decoy device which operably retrieves downed, floating waterfowl, game or other surface matter on a body of water while simultaneously breaking skim ice on the water surface. Further, the prior art perceives a need for remotely controlled waterfowl decoy apparatus or suitable other game decoy apparatus, which is capable of maintaining an ice-free surface so as to improve the environmental conditions for alluring waterfowl or other game birds to a given body of water.

### SUMMARY

Accordingly, it is an object of the present invention to provide a remotely controlled, water-borne vessel to retrieve downed, floating waterfowl, game or other floating matter on a given body of water, which water-borne vessel is sized, shaped and marked to resemble a waterfowl so as to encourage, attract or allure waterfowl, game birds or other species of game to the site of the water-borne vessel, namely the body of water into which the water-borne vessel is placed. It is a further object of the present invention to provide a remotely controlled waterfowl decoy apparatus or other suitable game decoy device which operably retrieves downed, floating waterfowl or other surface matter floating on a water surface in a body of water while simultaneously breaking skim ice on the water surface and further maintaining an ice-free surface so as to improve the environmental conditions for alluring waterfowl or other game birds to a given body of water.

To achieve these and other readily apparent objectives, the present invention provides an outfitted remote control decoy or waterfowl decoy system for retrieving or removing matter from a water surface, particularly downed, floating waterfowl, game or other surface matter. Simultaneously, the present invention further provides an alluring waterfowl decoy or game decoy for alluring waterfowl or other game to the body of water. In this regard, the waterfowl decoy system generally comprises remote control signal transmitter means, a buoyant decoy housing, and waterfowl-retrieving or matter-retrieving grappling means.

The remote control transmitter means is designed to transmit user or operator-generated signals to remote control signal receiver means housed in the buoyant decoy housing. The buoyant decoy housing is designed for floating or buoyant placement on a substantially planar water body surface. The buoyant decoy housing further comprises a waterfowl-alluring upper portion, having head, breast, body, and tail portions, each of which preferably have waterfowl-simulative markings for alluring waterfowl.

Waterfowl-alluring upper portion further comprises a removable cover, which enables entry into an interior decoy housing chamber. The interior decoy housing chamber is designed to house remote control signal receiver means, a rotatable-wing motor assembly, and a propulsion motor assembly. The rotatable-wing motor assembly is capable of creating and transferring rotational power to a shaft member for rotating a pair of wing members for animating the remote control decoy to further allure waterfowl or other similar game.

The buoyant decoy housing further comprises a hull-shaped lower portion, which further comprises propulsion means for propelling the buoyant decoy housing through the substantially planar water surface. The propulsion motor assembly is capable of creating and transferring power to the propulsion means for operatively propelling and steering the buoyant decoy housing through the substantially planar water surface for alluring waterfowl. The hull-shaped lower portion and the propulsion means may be specifically colored to reflect more accurate waterfowl coloration or other suitable game coloration for waterfowl-alluring or game-alluring purposes. In this regard, the hull-shaped lower portion preferably has waterfowl-simulative coloration or game-simulative coloration to approximate the outer apparent coloration of a typical waterfowl or other species of game. Similarly, the propulsion means or, typically, screw-type propellers, may include waterfowl foot or game foot coloration to approximate the outer apparent foot coloration of a typical waterfowl or other species of game.

The waterfowl-retrieving or matter-retrieving grappling means is designed to receive and securely hold downed, floating waterfowl, game or other surface matter and is mounted to the anterior or breast portion of the buoyant decoy housing. The grappling means may be further defined by comprising a series of forwardly extending prongs mounted to a central junction hub all of which may include light absorbent coloration so as to not detract from the alluring effect of the waterfowl decoy system.

The waterfowl-retrieving or matter-retrieving grapple means thus enables users to retrieve downed, floating waterfowl, game, or other surface matter. This is achieved by remotely steering and propelling the buoyant decoy housing into downed, floating waterfowl, game or other surface matter; grappling the downed, floating waterfowl, game or surface matter as the case may be; and by further steering and propelling the buoyant decoy housing to a waterfowl, game or surface matter recipient for retrieving the downed, floating waterfowl, game or other surface matter.

An alternative embodiment of the present invention concerns a waterfowl decoy system or game decoy system for removing surface matter or breaking skim ice formed on the surface of the substantially planar water body surface. The alternative embodiment of the present invention is virtually identical to the preferred embodiment save for the replacement of the waterfowl-retrieving or matter-retrieving grapple means with ice-breaking means. The ice-breaking means may be removably attached to the buoyant decoy housing at the breast portion in tandem with the water-retrieving or matter-retrieving grappling means or in isolation depending on the function desired by the user.

The ice-breaking means comprises an angled member, which has a forward, ice-breaking edge and a superior attachment end, which attachment end may be removably attached to the central junction hub. The ice-breaking means also may include light absorbent coloration to increase the alluring effect of the waterfowl or game decoy system. The ice-breaking forward edge thus enables users to break through skim ice formed on the substantially planar water surface to create or maintain an ice-free water surface for alluring waterfowl or similar other game to the body of water.

Additionally, a method of retrieving downed, floating waterfowl, game or other surface matter from a water surface is disclosed comprising the steps of (1) providing at least one outfitted remote control decoy as described for retrieving downed, floating waterfowl, game or other surface matter from a body of water; (2) remotely propelling and steering the outfitted remote control decoy into adjacency with downed, floating waterfowl, game or other surface matter on a body of water, thus bringing the downed, floating waterfowl, game or other surface matter into contact with the waterfowl-retrieving or matter-retrieving grappling means; (3) remotely grappling the downed, floating waterfowl, game or other surface matter with the waterfowl-retrieving or matter-retrieving grappling means; and (4) remotely propelling and steering the outfitted remote control decoy and grappled surface matter to a surface matter recipient. The user may thus retrieve downed, floating waterfowl, game or other surface matter from the body of water, which contributes to a matter-free water surface for further alluring waterfowl or other game to the body of water. The method may further comprise the additional step of remotely propelling and steering the outfitted remote control decoy through skim ice formed on the substantially planar water surface to create or maintain an ice-free water surface for further alluring waterfowl or game to the body of water.

### BRIEF DESCRIPTION OF THE DRAWINGS

Other features of our invention will become more evident from a consideration of the following brief detailed description of our patent drawings, as follows:

FIG. 1 is a perspective view of the preferred embodiment of the decoy system for retrieving surface matter from a body of water and for alluring waterfowl to the body of water.

FIG. 2 is right lateral side plan view of the buoyant decoy housing with attached matter-retrieving grapple means.

FIG. 3 is a fragmentary top plan view of the buoyant decoy housing with attached matter-retrieving grapple means.

FIG. 4 is anterior view of the buoyant decoy housing with wing members detached and with attached matter-retrieving grapple means.

FIG. 5 is a fragmentary bottom plan view of the buoyant decoy housing with attached matter-retrieving grapple means with parts broken away to show a propulsion motor assembly.

FIG. 6 is a top plan view of the buoyant decoy housing with attached matter-retrieving grapple means and with wing members detached operably retrieving a downed, floating waterfowl.

FIG. 7 is a fragmentary top plan view of the buoyant decoy housing with attached matter-retrieving grapple means, showing the removable cover in an open position thus exposing the interior housing chamber.

FIG. 8 is a right lateral side plan view of the buoyant decoy housing with attached matter-retrieving grapple means operably retrieving a downed, floating waterfowl.

FIG. 9 is a right lateral side plan view of the buoyant decoy housing with attached ice-breaking means.

FIG. 10 is a fragmentary, cross-sectional top plan view of the matter-retrieving grapple means and ice-breaking means in tandem assemblage with the breast portion of the buoyant decoy housing.

FIG. 11 is a top plan view of the buoyant decoy housing with wing members detached and attached ice-breaking means operably breaking skim ice.

FIG. 12 is a top plan view of two remotely controlled buoyant decoy housing units with attached ice-breaking means operably breaking skim ice on a bounded body of water.

FIG. 13 is a circuit diagram showing remote control receiver means, rotatable wing motor assembly, and propulsion motor assembly as housed in the interior decoy housing chamber.

### DETAILED DESCRIPTION OF THE PREFERRED EMBODIMENT

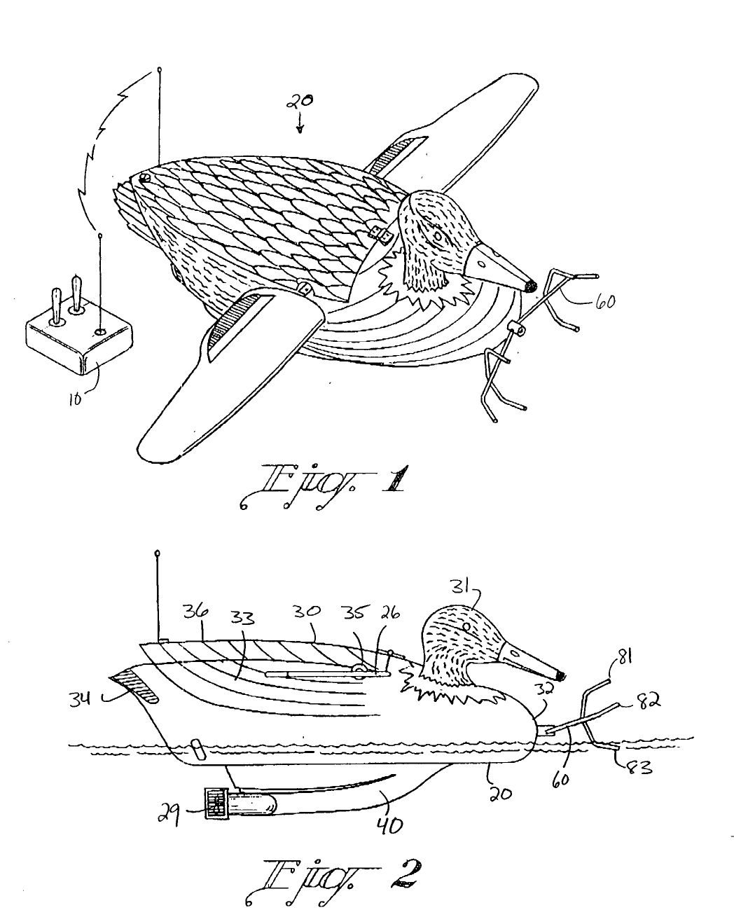

Referring now to the drawings, the preferred embodiment of the present invention concerns an outfitted remote control decoy or waterfowl decoy system for retrieving or removing downed, floating waterfowl, game or other surface matter from a body of water. Simultaneously, the present invention further provides an alluring waterfowl decoy or game decoy for alluring waterfowl or other game to the body of water. In this regard, the preferred embodiment of the waterfowl decoy system generally comprises remote control signal transmitter means 10; a buoyant decoy housing 20; and matter-removing means as illustrated in FIG. 1. In the preferred embodiment matter-removing means preferably comprises waterfowl-retrieving or matter-retrieving grappling means 60, as further illustrated in FIG. 1.

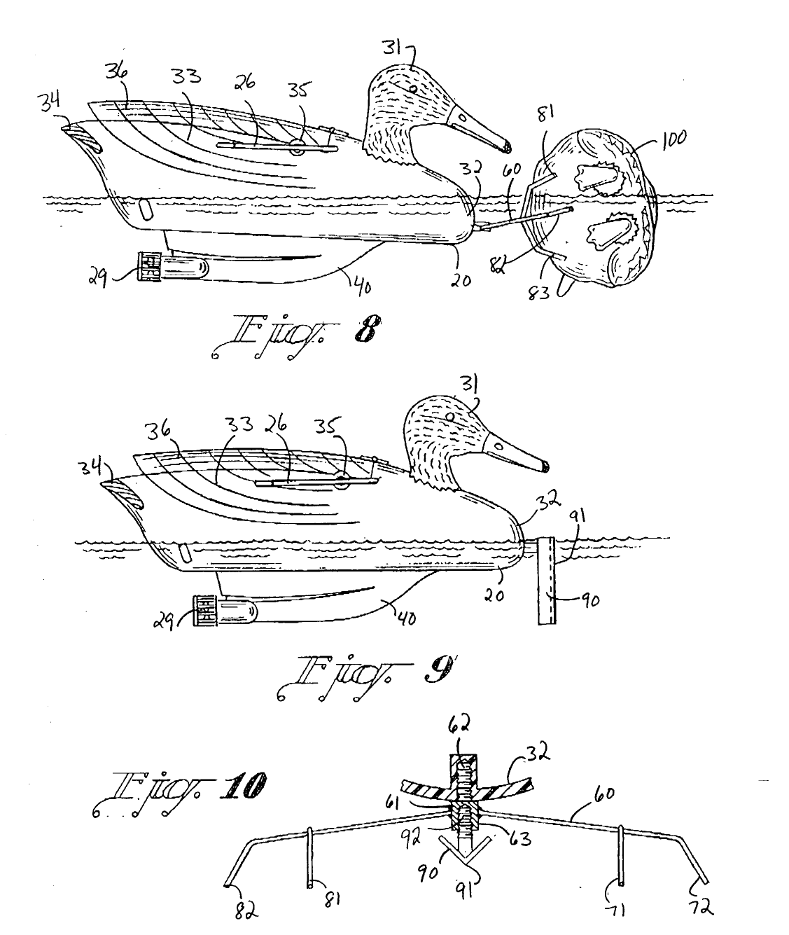

Remote control transmitter means 10 is designed to transmit user or operator-generated signals to remote control signal receiver means housed in buoyant decoy housing 20 as generally illustrated in FIG. 7. Buoyant decoy housing 20 is designed for floating or buoyant placement on a body of water as generally illustrated in FIGS. 1, 6 and 8. Notably, a given body of water will typically have a substantially planar water surface if the body of water is in a relatively non-agitated state or has low wave activity. FIGS. 2, 8, and 9 generally show a water surface in a relatively non-agitated state or with a substantially planar water surface.

Buoyant decoy housing 20 comprises a waterfowl-alluring upper portion 30. Waterfowl-alluring upper portion 30 further comprises a head portion 31 as illustrated in FIGS. 2, 3, 4, 6, 8 and 11; an anterior portion or breast portion 32 as illustrated in FIGS. 2, 4, 6 and 8; a body portion 33 as illustrated in FIGS. 2, 3, 6, 7 and 8; and a posterior portion or tail portion 34 as illustrated in FIGS. 2, 3, 5, 6, 7 and 8. As can be seen from a review of the figures, head portion 31, breast portion 32, body portion 33, and tail portion 34 each preferably have waterfowl-simulative markings for alluring waterfowl. In other words, waterfowl-alluring upper portion 30 is sized, shaped and provided with waterfowl-simulative markings to resemble a typical waterfowl species. Preferably, waterfowl-alluring upper portion 30 is constructed from a suitable lightweight, rigid, durable, moldable buoyant material such as plastic.

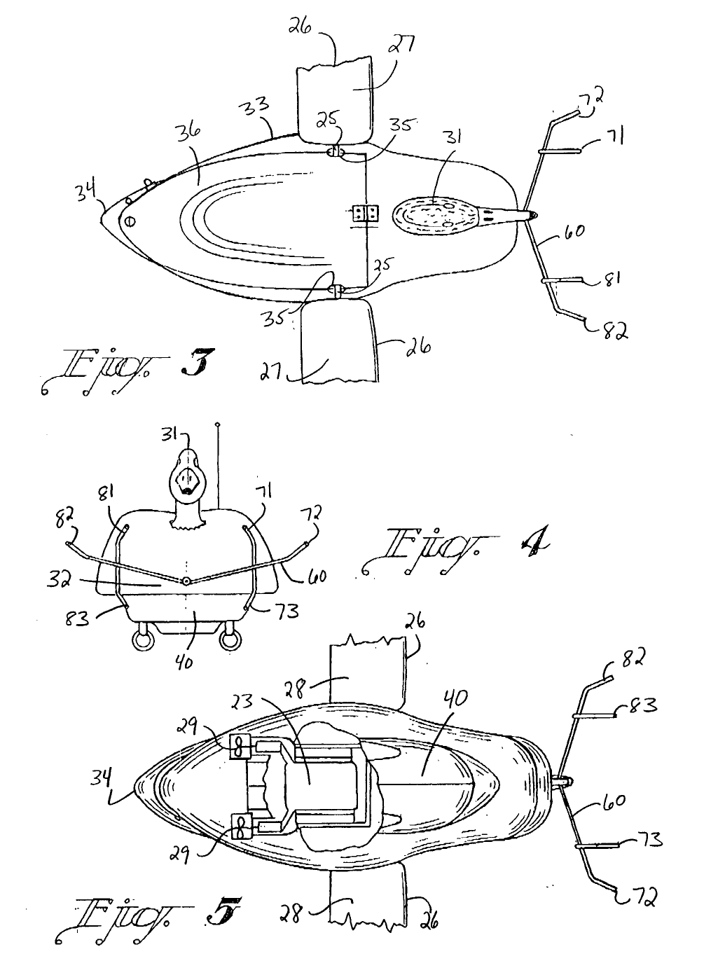

Waterfowl-alluring upper portion 30 further comprises a left lateral shaft end receiving aperture 35 as illustrated in FIG. 3 and a right lateral shaft end receiving aperture 35 as illustrated in FIGS. 2, 3, and 8. Waterfowl-alluring upper portion 30 further comprises a removable cover 36 as illustrated in FIGS. 2, 3, 6, 7, 8, and 11. Removable cover 36 enables entry into an interior decoy housing chamber 37 as generally illustrated in FIG. 7. As will be seen, removable cover 36 is preferably hingedly affixed to buoyant decoy housing 20 at a point posterior to head portion 31 as is generally illustrated in FIGS. 1, 3, 6, 8, and 11. Further, removable cover 36 is preferably secured to buoyant decoy housing 20 when in a closed state by fastening means or, preferably, a fastening screw, which screw may be located adjacent tail portion 34 as is generally illustrated in FIGS. 1, 3, 6, and 11.

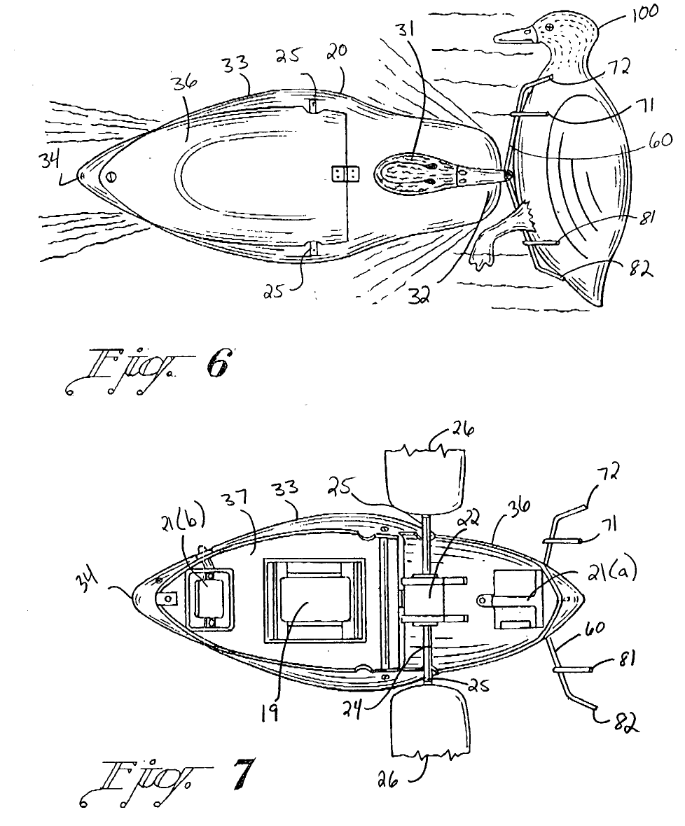

Interior decoy housing chamber 37 is designed to house remote control signal receiver means, a rotatable-appendage or rotatable-wing motor assembly 22 as shown in FIGS. 7 and 13, and a propulsion motor assembly 23 as shown in FIG. 5, all of which may preferably be switched on of off via a power switch 18 as illustrated in greater detail in FIG. 13. The remote control signal receiver means is illustrated comprising two separate receiving units. In the first instance, a rotatable motor receiver 21(a) is illustrated in FIGS. 7 and 13 and is designed to remotely control and drive rotatable-wing motor assembly 22. In the second instance, a propulsion motor receiver 21(b) is further illustrated in FIGS. 7 and 13. Propulsion motor receiver 21(b) is designed to remotely control and drive propulsion motor assembly 23 as is simply illustrated in FIG. 5. As can be seen from a general review of FIGS. 1, 2, and 4, propulsion motor receiver 21(b) may further comprise an antenna, which may be preferably located adjacent tail portion 34, to aid in the reception of user or operator-generated signals. Rotatable motor receiver 21(a) and propulsion motor receiver 21(b) are each designed to receive, decode and direct incoming user or operator-generated signals from remote control signal transmitter means 10. The remote control signal receiver means thus directs received, decoded signals via electrical circuitry as shown in FIG. 13 to electro-mechanical apparatus, often referred to in remote control modeling arts as a servo, which servo is responsive to received, decoded signals. The electro-mechanical apparatus thus selectively actuates rotatable-wing motor assembly 22 and propulsion motor assembly 23 for operatively driving rotatable-wing motor assembly 22 and propulsion motor assembly 23.

Rotatable-wing motor assembly 22 and propulsion motor assembly 23 each further comprise a power source 19 as illustrated in FIGS. 7 and 13 to provide energy to drive the respective components. In this regard, excellent results have been shown using battery means for powering the respective components. Choice in batteries typically lies between either the dry, alkaline batteries of the type used in transistorized radios, toys and so forth, or nickel cadmium cells. While the initial cost is less for dry, alkaline batteries, dry, alkaline batteries are less desirous in that they may be discarded prematurely due to the risk of running down during operation. Additionally, dry, alkaline batteries require frequent replacement when the electro-chemical energy potential is consumed or exhausted. Nickel, cadmium cells, when used and recharged correctly, can be recycled many hundreds of times and typically provide years of service. Further, a given nickel cadmium cell will last for the duration of a given hunt outing whereas dry, alkaline batteries last for significantly shorter periods of time. Thus, nickel-cadmium cells are the preferred power source to run rotatable-wing assembly 22 and propulsion motor assembly 23.

Rotatable-wing motor assembly 22 is thus capable of creating and transferring rotational power to a shaft member 24 as shown in FIG. 7. Shaft member 24 has a left lateral end 25 as illustrated in FIGS. 3, 6, and 7 and a right lateral end 25 as also illustrated in FIGS. 3, 6, and 7. Left lateral end 25 is designed to be received in left lateral shaft end receiving aperture 35 as generally illustrated in FIGS. 3 and 6 and right lateral end 25 is designed to be received in right lateral shaft end receiving aperture 35 as further generally illustrated in FIGS. 3 and 6. Left lateral end 25 has left wing or left appendage attachment means and right lateral end 25 has right wing or right appendage attachment means. The left and right wing attachment means are each preferably defined by comprising a wing rod receiving structure, which wing rod receiving structures are constructed by boring a hole longitudinally into left lateral end 25 and right lateral end 25.

A left lateral appendage or left lateral wing member 26 is optionally and removably attached to left lateral end 25 as illustrated in FIGS. 3 and 7. Left lateral wing member 26 preferably comprises a left wing rod and a left wing structure. The left wing rod is preferably constructed of a rigid durable metal material having circular longitudinal cross section and inserted longitudinally into the left wing structure by piercing the interstitial structure of the left wing structure. The left wing structure is preferably constructed of a lightweight corrugated plastic material having a piercable interstitial layer, thus allowing for easy insertion of the left wing rod. A right lateral appendage or right lateral wing member 26 is optionally and removably attached to right lateral end 25 as further illustrated in FIGS. 3 and 7. Right lateral wing member 26 has similar functionality to left lateral wing member 26 and thus is also optionally and removably attached to right lateral end 25 as illustrated in FIGS. 2, 3, 5, 7, and 8. Right lateral wing member 26 thus also comprises a right wing rod and a right wing structure. The right wing rod is also preferably constructed of a rigid durable metal material having circular longitudinal cross section and inserted longitudinally into the right wing structure by piercing the interstitial structure of the right wing structure. The right wing structure is also preferably constructed of a lightweight corrugated plastic material having a piercable interstitial layer, thus allowing for easy insertion of the right wing rod.

The diameter of each wing rod receiving structure is preferably slightly greater in dimension than the diameter of the left and right wing rods, thus allowing for easy insertion of the left and right wing rods into the left lateral end 25 and right lateral end 25, respectively. Wing rod fastening means, or preferably, fastening screws, thus fasten each wing rod into fixed attachment to the lateral ends. In this regard, the preferred fastening screws may be threadably inserted through respective, laterally-aligned, threaded bore holes in left lateral end 25 and right lateral end 25. As is common practice, the fastening screws may be easily screwed into the laterally-aligned bore holes to fasten each wing rod into fixed attachment.

Left lateral wing member 26 right lateral wing member 26 each further comprise a dorsal surface 27 as illustrated in FIG. 3, and a ventral surface 28 as illustrated in FIG. 4. Each dorsal surface 27 preferably comprises light-absorbent dorsal surface coloration and each ventral surface 28 preferably comprises light-reflective ventral surface coloration. When rotated, left lateral wing member 26 and right lateral wing member 26 thus create an alternating visual signal, for alluring waterfowl or similar other game. Preferably, the light-absorbent dorsal surface coloration further comprises a visual-identifying pattern as is generally illustrated in FIG. 1. The visual-identifying pattern creates a more alluring decoy system by creating a user-chosen, species-specific wing appearance.

It should be noted, that when left lateral wing member 26 and right lateral wing member 26 are optionally and removably attached to the left lateral end 25 and the right lateral end 25, respectively, buoyant decoy housing 20 may operate less efficiently insofar as the wing tips may dip into the water surface. It is for this reason that left lateral wing member 26 and right lateral wing member 26 may be optionally removed to increase the efficiency of the decoy system. As can be seen from a review of FIGS. 4, 6, 11, and 12, the decoy system or remote control decoy may be preferably operated without left lateral wing member 26 and right lateral wing member 26 attached to shaft member 24 as described, particularly when the substantially planar water surface becomes less planar or is in a more agitated state or when the outfitted remote control decoy or decoy system is being used to break skim ice or maintain an ice-free water surface, as described hereinafter under the section entitled DESCRIPTION OF THE ALTERNATIVE EMBODIMENT.

Buoyant decoy housing 20 further preferably comprises a hull-shaped lower portion 40 as illustrated in FIGS. 2, 4, 5, and 8. Hull-shaped lower portion 40 further comprises propulsion means for propelling buoyant decoy housing 20 through the substantially planar water surface. Propulsion motor assembly 23 is capable of creating and transferring power to the propulsion means for operatively propelling and steering buoyant decoy housing 20 through the substantially planar water surface for alluring waterfowl. The propulsion means are preferably further defined by comprising at least one screw propeller 29 as illustrated in FIGS. 2, 5, and 8.

Preferably, hull-shaped lower portion 40 and the propulsion means are specifically colored to reflect more accurate waterfowl or game coloration for waterfowl or game alluring purposes. In this regard, hull-shaped lower portion 40 preferably has waterfowl-simulative coloration or game-simulative coloration to approximate the outer apparent coloration of a typical waterfowl or other species of game. Similarly, the propulsion means, namely, screw propellers 29, preferably have waterfowl foot or game foot coloration to approximate the outer apparent foot coloration of a typical waterfowl or other species of game. While it is noted that hull-shaped portion 40 and the propulsion means are typically hidden from view when submerged below the substantially planar water surface, a given body of water may reflect submerged color attributes of buoyant decoy housing 20 and accordingly, hull-shaped lower portion 40 and screw propellers 29 or the propulsion means are colored so as to not detract from the waterfowl or game alluring characteristics of the present invention.

Waterfowl-retrieving or matter-retrieving grappling means 60 is designed to aid in the removal of matter from water surfaces by receiving and securely holding downed, floating waterfowl 100 or other surface matter as illustrated in FIGS. 6 and 8. As is illustrated in FIGS. 2, 3, 4, 5, 6, 8, and 10, waterfowl-retrieving or matter-retrieving grapple means 60 is removably mounted to the anterior portion or breast portion 32 of buoyant decoy housing 20. The mounting junction is preferably constructed by boring a threaded aperture into the anterior portion or breast portion 32 of buoyant decoy housing 20 as generally illustrated in FIG. 10. Waterfowl-retrieving or matter-retrieving grapple means 60 preferably comprises a series of forwardly extending prongs mounted to a central junction hub 61 as illustrated in FIG. 10. Central junction hub 61 has a male insertion end 62 and a female receiving end 63. Male insertion end 62 is preferably threaded and threadably inserted into the bored, threaded aperture of anterior portion or breast portion 32, thus fixedly attaching waterfowl-retrieving or mater-retrieving grapple means 60 to buoyant decoy housing 20. Female receiving end 63 also preferably comprises threaded receiving structure for receiving additional threaded structure, which is discussed in greater detail below under the section entitled DESCRIPTION OF THE ALTERNATIVE EMBODIMENT.

The series of forwardly extending prongs and central junction hub 61 are preferably constructed from durable metal materials. Furthermore, waterfowl-retrieving or mater-retrieving grapple means 60 is preferably colored to increase the alluring effect of the waterfowl decoy system. In this regard, waterfowl-retrieving or matter-retrieving grapple means 60 preferably comprises light-absorbent coloration approximating the visual coloration of a typical body of water.

The forwardly extending prongs preferably comprise a left lateral prong series and a right lateral prong series, the left lateral prong series comprising a left superior prong 71 as illustrated in FIGS. 3, 4, 6, 7, and 10; a left inferior prong 73 as illustrated in FIGS. 4 and 5; and a left intermediate prong 72 as illustrated in FIGS. 3, 4, 5, 6, 7, and 10. The right lateral prong series comprises a right superior prong 81 as illustrated in FIGS. 2, 3, 4, 6, 7, 8, and 10; a right inferior prong 83 as illustrated in FIGS. 2, 4, 5, and 8; and a right intermediate prong 82 as illustrated in FIGS. 2, 3, 4, 5, 6, 7, 8, and 10. Left inferior prong 73 and right inferior prong 83 are spatially located so as to extend forwardly in a plane substantially equal to the substantially planar water surface when floatingly placed onto a body of water as generally illustrated in FIG. 2. The described spatial orientation of left inferior prong 73 and right inferior prong 83 is preferred so as to avoid grappling matter located just before the water surface, such as sea weed and the like.

Typically, downed, floating waterfowl 100 as shown in FIGS. 6 and 8 float on water surfaces such that approximately ⅔ of the downed bird is below the water line as specifically shown in FIG. 8. As will be further seen, left superior prong 71 and right superior prong 81 are designed to receive and securely hold superior portions of downed, floating waterfowl 100 or other surface matter as specifically illustrated in FIG. 6 and as generally illustrated in FIG. 8. Left intermediate prong 72 and right intermediate prong 82 are designed to receive and securely hold intermediate portions of downed, floating waterfowl 100 or other surface matter as specifically illustrated in FIG. 6 and as generally illustrated in FIG. 8. Left inferior prong 73 and right inferior prong 83 are designed to receive and securely hold inferior portions of downed, floating waterfowl 100 or other surface matter as generally illustrated in FIG. 8. As comparatively shown in FIG. 2 versus FIG. 8, the series of forwardly extending prongs shift in spatial orientation such that left inferior prong 73, right inferior prong 83, left intermediate prong 72, and right intermediate prong 82 usually become submerged below the water line when grappling downed, floating waterfowl 100. It is noted that when a downed, floating waterfowl 100 is so grappled, waterfowl-retrieving or matter-retrieving grappling means 60 is unlikely to snag or grapple seaweed and the like since the grappled surface matter or downed, floating waterfowl 100 provides a shield to waterfowl-retrieving or matter-retrieving grapple means 60 to deflect matter below the water surface as generally illustrated in FIGS. 6 and 8.

Waterfowl-retrieving or matter-retrieving grapple means 60 thus enables users to retrieve downed, floating waterfowl 100, game, or other surface matter. This is achieved by remotely steering and propelling buoyant decoy housing 20 into downed, floating waterfowl 100, game or other surface matter; grappling the downed, floating waterfowl 100, game or other surface matter as illustrated in FIGS. 6 and 8; and by further steering and propelling buoyant decoy housing 20 to a waterfowl, game or surface matter recipient for retrieving downed, floating waterfowl 100, game or other surface matter.

### DESCRIPTION OF THE ALTERNATIVE EMBODIMENT

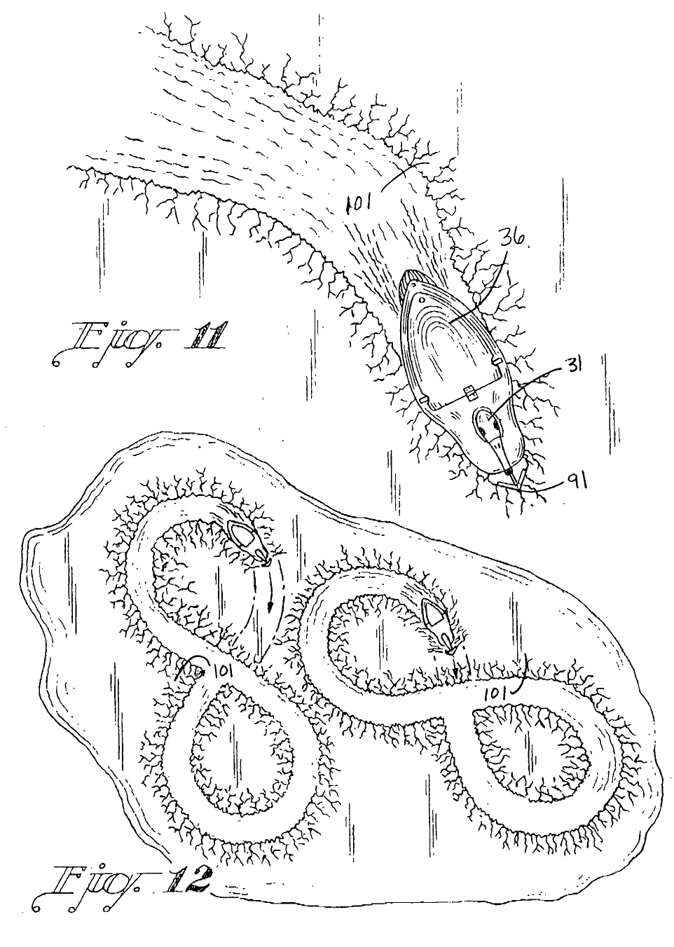

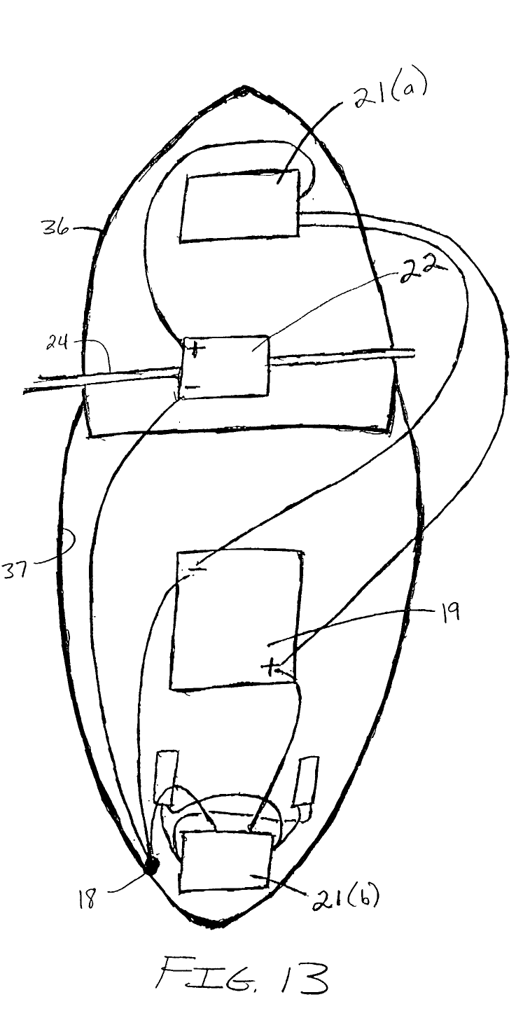

As illustrated in FIG. 9, an alternative embodiment of the present invention concerns a waterfowl decoy or game decoy system for removing surface matter or breaking skim ice 101 formed on the surface of the substantially planar water surface of a given body of water as illustrated in FIGS. 11 and 12. The alternative embodiment of the present invention is virtually identical to the preferred embodiment of the present invention save for the replacement of waterfowl-retrieving or matter-retrieving grapple means 60 with ice-breaking means 90 as specifically illustrated in FIG. 9 and as comparatively illustrated in FIG. 2 versus FIG. 9. It will thus be seen that in the alternative embodiment the matter-removing means preferably comprises ice-breaking means 90. It is further contemplated that ice-breaking means 90 may be removably attached to buoyant decoy housing 20 at anterior portion or breast portion 32 in tandem or in adjacency to water-retrieving or matter-retrieving grappling means 60 as further illustrated in FIG. 10.

Ice-breaking means 90 preferably comprises an angled member, which has a forward, ice-breaking edge 91 as shown in FIGS. 9, 10, and 11, and a superior attachment end as generally illustrated in FIGS. 9 and 10. Ice-breaking means 90 is preferably constructed of a lightweight durable metal material, such as aluminum. Furthermore, ice-breaking means 90 is preferably colored to increase the alluring effect of the waterfowl or game decoy system. In this regard, ice-breaking means 90 preferably comprises light-absorbent coloration approximating the visual coloration of a typical body of water.

The superior attachment end preferably comprises threaded male insertion structure 92, which is selectively inserted into either female receiving end 63 as illustrated in FIG. 10 or anterior portion or breast portion 32 as shown in FIG. 9 for fixedly attaching or mounting ice-breaking means 90 to buoyant decoy housing 20. Ice-breaking edge 91 is designed to cut or break through skim ice formed on the substantially planar water surface and the superior attachment end removably mounts ice-breaking means 90 to breast portion 32, thus enabling users to break through skim ice formed on the substantially planar water surface to create or maintain an ice-free water surface for alluring waterfowl or game to the body of water.

Skim ice is herein defined as surface ice formed on a water surface having a thickness no greater than ¼ inch thickness. Ice having thickness greater than ¼ inch will often require additional efforts to be broken. However, the alternative decoy system employing ice-breaking means 90 for breaking skim ice formed on the substantially planar water surface will maintain an ice-free water surface once ice having thickness greater than ¼ inch is broken by additional effort. Excellent results have been shown when the alternative decoy system employing ice-breaking means 90 is steered and propelled atop a body of water having skim ice less than ¼ inch in thickness as generally illustrated in FIGS. 11 and 12. Typically, “figure 8” patterns may be traced out by steering and propelling an outfitted buoyant decoy housing 20 as shown in FIG. 12 until the body of water has an ice-free water surface. As has been repeatedly stated, once free of ice, a water surface is typically more alluring to waterfowl or game. The present invention thus serves to allure waterfowl or game to a water surface by breaking skim ice and/or maintaining an ice-free water surface. When buoyant decoy housing 20 is additionally outfitted with waterfowl-retrieving or matter-retrieving grapple means 60, users may additionally retrieve downed, floating waterfowl 100, game or other surface matter in the manner described.

### DESCRIPTION OF THE METHOD

Additionally, a method of retrieving waterfowl, game, or other surface matter from a water surface is disclosed. In this regard, the method of retrieving floating, downed waterfowl, game or other surface matter from a water surface comprises the steps of (1) providing at least one outfitted remote control decoy as described herein for retrieving waterfowl, game or other surface matter from a body of water; (2) remotely propelling and steering the outfitted remote control decoy into adjacency with a floating, downed waterfowl, game or other surface matter, thus bringing the floating, downed waterfowl, game or other surface matter into contact with waterfowl-retrieving or matter-retrieving grappling means 60; (3) remotely grappling floating, downed waterfowl, game or other surface matter with waterfowl-retrieving or matter-retrieving grappling means 60; (4) remotely propelling and steering the outfitted remote control decoy and grappled waterfowl, game or other surface matter to a surface matter recipient, thus retrieving floating, downed waterfowl, game or other surface matter from the body of water and thus contributing to a matter-free water surface for alluring waterfowl or other game to the body of water. Alternatively, the method comprises the additional step of remotely propelling and steering the outfitted remote control decoy through skim ice formed on the substantially planar water surface to create or maintain an ice-free water surface for alluring waterfowl or game to the body of water.

It will thus be seen that the present invention provides a remotely controlled, water-borne vessel to retrieve floating, downed waterfowl, game or other floating matter on a given body of water, which water-borne vessel is sized, shaped and marked to resemble a waterfowl or other suitable species of game so as to encourage or attract waterfowl or game birds or other suitable species of game to the site of the water-borne vessel, namely the body of water into which the water-borne vessel is placed. It will thus be further seen that the present invention provides a remotely controlled waterfowl decoy apparatus or other suitable game decoy device which operably retrieves downed, floating waterfowl, game or other surface matter floating on a water surface while simultaneously breaking skim ice on the water surface and further maintaining an ice-free surface so as to improve the environmental conditions for alluring waterfowl or other species of game to a given body of water.

While the above description contains much specificity, this specificity should not be construed as limitations on the scope of the invention, but rather as an exemplification of the invention. For example, the propulsion means need not comprise two screw-type propellers of the type disclosed and illustrated. So long as the propulsion means is capable of propelling and steering the buoyant decoy housing through the water surface of a given body of water, the propulsion means successfully fulfills its propulsion purpose. In this regard, should a single screw propeller be utilized to propel the buoyant decoy through a water surface, a steering rudder may be utilized to steer the buoyant decoy housing.

Furthermore, it is contemplated that 40 lower portion, which is preferably hull-shaped, need not approximate a typical boat hull design as generally illustrated herein. So long as the hull-shaped lower portion enables buoyant decoy housing 20 to be propelled and steered through a water surface, the hull-shaped lower portion successfully fulfill its water-cutting purpose. In this regard, it is contemplated that the hull-shaped lower portion may approximate the typically submerged ventral surface of a waterfowl or similar other species of game, which may easily cut through a water surface.

Accordingly, although the invention has been described by reference to a preferred embodiment, it is not intended that the novel device be limited thereby, but that modifications thereof are intended to be included as falling within the broad scope and spirit of the foregoing disclosure, the following claims and the appended drawings.

We claim:

1. A waterfowl decoy system for retrieving waterfowl from a body of water and for alluring waterfowl to the body of water, the waterfowl decoy system comprising:
remote control signal transmitter means, the remote control transmitter means for transmitting user signals to remote control signal receiver means;
a buoyant decoy housing, the buoyant decoy housing for floating placement on a body of water, the body of water having a substantially planar water surface, the buoyant decoy housing further comprising a waterfowl-alluring upper portion and a hull-shaped lower portion, the waterfowl-alluring upper portion comprising a head portion, a breast portion, a body portion, and a tail portion, the head portion, breast portion, body portion, and tail portion each having waterfowl-simulative markings for alluring waterfowl, the waterfowl-alluring upper portion further comprising a left lateral shaft end receiving aperture and a right lateral shaft end receiving aperture, the waterfowl-alluring upper portion further comprising a removable cover, the removable cover for enabling entry into an interior decoy housing chamber, the interior decoy housing chamber housing the remote control signal receiver means, a rotatable-wing motor assembly, and a propulsion motor assembly, the remote control signal receiver means for receiving, decoding and directing signals from the remote control signal transmitter means, the remote control signal receiver means directing received, decoded signals to electro-mechanical apparatus responsive to received, decoded signals for selectively actuating the rotatable-wing motor assembly and the propulsion motor assembly for operatively driving the rotatable-wing motor assembly and the propulsion motor assembly, the rotatable-wing motor assembly capable of creating and transferring rotational power to a shaft member, the shaft member having a left lateral end and a right lateral end, the left lateral end being received in the left lateral shaft end receiving aperture, the right lateral end being received in the right lateral shaft end receiving aperture, the left lateral end having left wing attachment means, the right lateral end having right wing attachment means, the hull-shaped lower portion further comprising propulsion means for propelling the buoyant decoy housing through the substantially planar water surface, the propulsion motor assembly capable of creating and transferring power to the propulsion means for operatively propelling and steering the buoyant decoy housing through the substantially planar water surface for alluring waterfowl; and
waterfowl-retrieving grapple means for receiving and securely holding downed, floating waterfowl, the waterfowl-retrieving grapple means being removably mounted to the breast portion, the waterfowl-grapple means further comprising a series of forwardly extending prongs, the forwardly extending prongs comprising a left lateral prong series and a right lateral prong series, the left lateral prong series comprising a left superior prong, a left inferior prong, and a left intermediate prong, the right lateral prong series comprising a right superior prong, a right inferior prong, and a right intermediate prong, the left inferior prong and the right inferior prong being spatially located so as to extend forwardly in a plane substantially equal to the substantially planar water surface, the left superior prong and the right superior prong for receiving and securely holding superior portions of downed, floating waterfowl, the left intermediate prong and right intermediate prong for receiving and securely holding intermediate portions of downed, floating waterfowl, the left inferior prong and the right inferior prong for receiving and securely holding inferior portions of downed, floating waterfowl, the waterfowl-retrieving grapple means thus enabling users to retrieve downed, floating waterfowl by remotely steering and propelling the buoyant decoy housing into downed, floating waterfowl, grappling downed, floating waterfowl, and by further steering and propelling the buoyant decoy housing to a waterfowl recipient for retrieving the downed, floating waterfowl.

2. The waterfowl decoy system of claim 1 wherein a left lateral wing member is removably attached to the left lateral end and a right lateral wing member is removably attached to the right lateral end, the rotatable-wing motor assembly for selectively rotating the left lateral wing member and the right lateral wing member for alluring waterfowl.

3. The waterfowl decoy system of claim 2 wherein the left lateral wing member and right lateral wing member each further comprise a dorsal surface and a ventral surface, each dorsal surface having light-absorbent dorsal surface coloration and each ventral surface having light-reflective ventral surface coloration.

4. The waterfowl decoy system of claim 3 wherein the light-absorbent dorsal surface coloration further comprises a visual identifying pattern.

5. The waterfowl decoy system of claim 1 wherein the propulsion means is further defined by comprising at least one screw propeller.

6. The decoy system of claim 5 wherein the hull-shaped lower portion is further defined by comprising waterfowl-simulative coloration, the propulsion means is further defined by comprising waterfowl foot coloration, and the waterfowl-retrieving grapple means is further defined by comprising light-absorbent coloration.

7. A decoy system for removing surface matter from a body of water and alluring game to the body of water, the decoy system comprising:
remote control signal transmitter means, the remote control transmitter means for transmitting user signals to remote control signal receiver means;
a buoyant decoy housing, the buoyant decoy housing for floating placement on a body of water, the body of water having a substantially planar water surface, the buoyant decoy housing further comprising a game-alluring upper portion and a hull-shaped lower portion, the game-alluring upper portion comprising an anterior portion and a posterior portion, the anterior portion and posterior portion each having game-simulative markings for alluring game, the game-alluring upper portion further comprising a removable cover, the removable cover for enabling entry into an interior decoy housing chamber, the interior decoy housing chamber for housing the remote control signal receiver means and a propulsion motor assembly, the remote control signal receiver means for receiving, decoding and directing signals from the remote control signal transmitter means, the remote control signal receiver means directing received, decoded signals to electro-mechanical apparatus responsive to received, decoded signals for selectively actuating the propulsion motor assembly for operatively driving the propulsion motor assembly, the hull-shaped lower portion further comprising propulsion means for propelling the buoyant decoy housing through the substantially planar water surface, the propulsion motor assembly capable of creating and transferring power to the propulsion means for operatively propelling and steering the buoyant decoy housing through the substantially planar water surface for alluring game; and
matter-retrieving grapple means for receiving and securely holding surface matter, the matter-retrieving grapple means being removably mounted to the anterior portion, the matter-retrieving grapple means thus enabling users to remove surface matter by remotely steering and propelling the buoyant decoy housing into surface matter, grappling the surface matter, and by further steering and propelling the buoyant decoy housing to the surface matter recipient for removing the surface matter.

8. The decoy system of claim 7 wherein the decoy system is further defined by comprising ice-breaking means for breaking skim ice formed on the substantially planar water surface, the ice-breaking means being removably mounted to the anterior portion in adjacency to the matter-retrieving grapple means, thus enabling users to break through skim ice formed on the substantially planar water surface to create an ice-free water surface for alluring game to the body of water.

9. The decoy system of claim 7 wherein the game-alluring upper portion is further defined by comprising a left lateral shaft end receiving aperture and a right lateral shaft end receiving aperture, wherein the interior decoy housing chamber is further defined by housing a rotatable-appendage motor assembly, the rotatable-appendage motor assembly capable of creating and transferring rotational power to a shaft member, the shaft member having a left lateral end and a right lateral end, the left lateral end being received in the left lateral shaft end receiving aperture, the right lateral end being received in the right lateral shaft end receiving aperture, the left lateral end having left appendage attachment means, the right lateral end having right appendage attachment means.

10. The decoy system of claim 9 wherein a left lateral appendage is removably attached to the left lateral end and a right lateral appendage is removably attached to the right lateral end, the rotatable-appendage motor assembly for selectively rotating the left lateral appendage and the right lateral appendage for alluring game.

11. The decoy system of claim 7 wherein the matter-retrieving grapple means is further defined by comprising a series of forwardly extending prongs, the forwardly extending prongs comprising a left lateral prong series and a right lateral prong series, the left lateral prong series comprising a left superior prong, a left inferior prong, and a left intermediate prong, the right lateral prong series comprising a right superior prong, a right inferior prong, and a right intermediate prong, the left inferior prong and the right inferior prong being spatially located so as to extend forwardly in a plane substantially equal to the substantially planar water surface, the left superior prong and the right superior prong for receiving and securely holding superior portions of surface matter, the left intermediate prong and right intermediate prong for receiving and securely holding intermediate portions of surface matter, the left inferior prong and the right inferior prong for receiving and securely holding inferior portions of surface matter.

12. The decoy system of claim 7 wherein the propulsion means is further defined by comprising at least one screw propeller.

13. The decoy system of claim 7 wherein the hull-shaped lower portion is further defined by comprising game-simulative coloration, the propulsion means is further defined by comprising game foot coloration, and the matter-retrieving grapple means is further defined by comprising light-absorbent coloration.

14. A waterfowl decoy system for removing surface matter from a body of water for alluring waterfowl to the body of water, the waterfowl decoy system comprising:
remote control signal transmitter means, the remote control transmitter means for transmitting user signals to remote control signal receiver means;
a buoyant decoy housing, the buoyant decoy housing for floating placement on a body of water, the body of water having a substantially planar water surface, the buoyant decoy housing further comprising a waterfowl-alluring upper portion and a hull-shaped lower portion, the waterfowl-alluring upper portion comprising a head portion, a breast portion, a body portion, and a tail portion, the head portion, the breast portion, the body portion, and the tail portion each having waterfowl-simulative markings for alluring waterfowl, the waterfowl-alluring upper portion further comprising a left lateral shaft end receiving aperture and a right lateral shaft end receiving aperture, the waterfowl-alluring upper portion further comprising a removable cover, the removable cover for enabling entry into an interior decoy housing chamber, the interior decoy housing chamber housing the remote control signal receiver means, a rotatable-wing motor assembly, and a propulsion motor assembly, the remote control signal receiver means for receiving, decoding and directing signals from the remote control signal transmitter means, the remote control signal receiver means directing received, decoded signals to electro-mechanical apparatus responsive to received, decoded signals for selectively actuating the rotatable-wing motor assembly and the propulsion motor assembly for operatively driving the rotatable-wing motor assembly and the propulsion motor assembly, the rotatable-wing motor assembly capable of creating and transferring rotational power to a shaft member, the shaft member having a left lateral end and a right lateral end, the left lateral end being received in the left lateral shaft end receiving aperture, the right lateral end being received in the right lateral shaft end receiving aperture, the left lateral end having left wing attachment means, the right lateral end having right wing attachment means, the hull-shaped lower portion further comprising waterfowl-simulative coloration, the hull-shaped lower portion further comprising propulsion means for propelling the buoyant decoy housing through the surface of the body of water, the propulsion motor assembly capable of creating and transferring power to the propulsion means for operatively propelling and steering the buoyant decoy housing through a body of water for alluring waterfowl; and
ice-breaking means for breaking skim ice formed on the substantially planar water surface, the ice-breaking means being removably mounted to the breast portion, the ice-breaking means comprising light absorbent coloration, the ice-breaking means further comprising an angled member, the angled member having a forward, ice-cutting edge and a superior attachment end, the ice-cutting edge for cutting through skim ice formed on the substantially planar water surface, the superior attachment end removably mounting the ice-breaking means to the breast portion, thus enabling users to break through skim ice formed on the substantially planar water surface to create an ice-free water surface for alluring waterfowl to the body of water.

15. The waterfowl decoy system of claim 14 wherein a left lateral wing member is removably attached to the left lateral end and a right lateral wing member is removably attached to the right lateral end, the rotatable-wing motor assembly for selectively rotating the left lateral wing member and the right lateral wing member for alluring waterfowl.

16. The decoy system of claim 14 wherein the propulsion means is further defined by comprising at least one screw propeller.

17. A decoy system for removing surface matter from a body of water and alluring game to the body of water, the decoy system comprising:
remote control signal transmitter means, the remote control transmitter means for transmitting user signals to remote control signal receiver means;
a buoyant decoy housing, the buoyant decoy housing for floating placement on a body of water, the body of water having a substantially planar water surface, the buoyant decoy housing further comprising a game-alluring upper portion and a hull-shaped lower portion, the game-alluring upper portion comprising an anterior portion and a posterior portion, the anterior portion and posterior portion each having game-simulative markings for alluring game, the game-alluring upper portion further comprising a removable cover, the removable cover for enabling entry into an interior decoy housing chamber, the interior decoy housing chamber for housing the remote control signal receiver means and a propulsion motor assembly, the remote control signal receiver means for receiving, decoding and directing signals from the remote control signal transmitter means, the remote control signal receiver means directing received, decoded signals to electro-mechanical apparatus responsive to received, decoded signals for selectively actuating the propulsion motor assembly for operatively driving the propulsion motor assembly, the hull-shaped lower portion further comprising propulsion means for propelling the buoyant decoy housing through the substantially planar water surface, the propulsion motor assembly capable of creating and transferring power to the propulsion means for operatively propelling and steering the buoyant decoy housing through the substantially planar water surface for alluring game; and
ice-breaking means for breaking skim ice formed on the substantially planar water surface, the ice-breaking means being removably mounted to the anterior portion, thus enabling users to break through skim ice formed on the substantially planar water surface to create an ice-free water surface for alluring game to the body of water.

18. The decoy system of claim 17 wherein the ice-breaking means is further defined by comprising an angled member, the angled member having a forward, ice-breaking edge and a superior attachment end, the ice-breaking edge for breaking through skim ice formed on the substantially planar water surface, the superior attachment end removably mounting the ice-breaking means to the anterior portion.

19. The decoy system of claim 17 wherein the propulsion means is further defined by comprising at least one screw propeller.

20. The decoy system of claim 17 wherein the hull-shaped lower portion is further defined by comprising game-simulative coloration, the propulsion means is further defined by comprising game foot coloration, and the ice-breaking means is further defined by comprising light-absorbent coloration.

21. The decoy system of claim 17 wherein the game-alluring upper portion is further defined by comprising a left lateral shaft end receiving aperture and a right lateral shaft end receiving aperture, wherein the interior decoy housing chamber is further defined by housing a rotatable-appendage motor assembly, the rotatable-appendage motor assembly capable of creating and transferring rotational power to a shaft member, the shaft member having a left lateral end and a right lateral end, the left lateral end being received in the left lateral shaft end receiving aperture, the right lateral end being received in the right lateral shaft end receiving aperture, the left lateral end having left appendage attachment means, the right lateral end having right appendage attachment means.

22. The decoy system of claim 21 wherein a left lateral appendage is removably attached to the left lateral end and a right lateral appendage is removably attached to the right lateral end, the rotatable-appendage motor assembly for selectively rotating the left lateral appendage and the right lateral appendage for alluring game

23. A method of retrieving surface matter from a body of water and alluring game to the body of water, the method comprising the steps of:
providing at least one outfitted remote control decoy for retrieving surface matter from a body of water, the outfitted remote control decoy comprising:
remote control signal transmitter means, the remote control transmitter means for transmitting user signals to remote control signal receiver means;
a buoyant decoy housing, the buoyant decoy housing for floating placement on a body of water, the body of water having a substantially planar water surface, the buoyant decoy housing further comprising a game-alluring upper portion and a hull-shaped lower portion, the game-alluring upper portion comprising an anterior portion and a posterior portion, the anterior portion and posterior portion each having game-simulative markings for alluring game, the game-alluring upper portion further comprising a removable cover, the removable cover for enabling entry into an interior decoy housing chamber, the interior decoy housing chamber for housing remote control signal receiver means and a propulsion motor assembly, the remote control signal receiver means for receiving, decoding and directing signals from the remote control signal transmitter means, the remote control signal receiver means directing received, decoded signals to electro-mechanical apparatus responsive to received, decoded signals for selectively actuating the propulsion motor assembly for operatively driving the propulsion motor assembly, the hull-shaped lower portion further comprising propulsion means for propelling the buoyant decoy housing through the substantially planar water surface, the propulsion motor assembly capable of creating and transferring power to the propulsion means for operatively propelling and steering the buoyant decoy housing through the substantially planar water surface for alluring game;
matter-retrieving grapple means for receiving and securely holding surface matter, the matter-retrieving grapple means being removably mounted to the anterior portion,
remotely propelling and steering the outfitted remote control decoy into adjacency with surface matter on a body of water, thus bringing surface matter into contact with the matter-retrieving grappling means;
remotely grappling surface matter with the grappling means;
remotely propelling and steering the outfitted remote control decoy and grappled surface matter to a surface matter recipient, thus retrieving surface matter from the body of water and alluring game to the body of water.

24. The method of retrieving surface matter from a body of water of claim 23 wherein the outfitted remote control decoy is further defined by comprising ice-breaking means for breaking skim ice formed on the substantially planar water surface, the ice-breaking means being removably mounted to the anterior portion in adjacency to the matter-retrieving grappling means.

25. The method of retrieving surface matter from a body of water of claim 24 where the method comprises the additional step of remotely propelling and steering the outfitted remote control decoy through skim ice formed on the substantially planar water surface to create an ice-free water surface for alluring game to the body of water.

26. A method of removing surface matter from a body of water and alluring game to the body of water, the method comprising the steps of:
providing at least one outfitted remote control decoy for removing surface matter from a body of water, the outfitted remote control decoy comprising:
remote control signal transmitter means, the remote control transmitter means for transmitting user signals to remote control signal receiver means;
a buoyant decoy housing, the buoyant decoy housing for floating placement on a body of water, the body of water having a substantially planar water surface, the buoyant decoy housing further comprising a game-alluring upper portion and a hull-shaped lower portion, the game-alluring upper portion comprising an anterior portion and a posterior portion, the anterior portion and posterior portion each having game-simulative markings for alluring game, the game-alluring upper portion further comprising a removable cover, the removable cover for enabling entry into an interior decoy housing chamber, the interior decoy housing chamber for housing the remote control signal receiver means and a propulsion motor assembly, the remote control signal receiver means for receiving, decoding and directing signals from the remote control signal transmitter means, the remote control signal receiver means directing received, decoded signals to electro-mechanical apparatus responsive to received, decoded signals for selectively actuating the propulsion motor assembly for operatively driving the propulsion motor assembly, the hull-shaped lower portion further comprising propulsion means for propelling the buoyant decoy housing through the substantially planar water surface, the propulsion motor assembly capable of creating and transferring power to the propulsion means for operatively propelling and steering the buoyant decoy housing through the substantially planar water surface for alluring game;
ice-breaking means for breaking skim ice formed on the substantially planar water surface, the ice-breaking means being removably mounted to the anterior portion in adjacency to the matter-retrieving grappling means;
remotely propelling and steering the outfitted remote control decoy through skim ice formed on the substantially planar water surface to create an ice-free water surface for alluring game to the body of water.

27. The method of removing surface matter from a body of water of claim 26 wherein the outfitted remote control decoy is further defined by comprising matter-retrieving grapple means for receiving and securely holding surface matter, the matter-retrieving grapple means being removably mounted to the anterior portion.

28. The method of removing surface matter from a body of water of claim 27 wherein the method comprises the additional steps of:
remotely propelling and steering the outfitted remote control decoy into adjacency with surface matter on a body of water, thus bringing surface matter into contact with the matter-retrieving grappling means;
remotely grappling surface matter with the grappling means;
remotely propelling and steering the outfitted remote control decoy and grappled surface matter to a surface matter recipient, thus removing surface matter from the body of water and alluring game to the body of water.

29. A decoy system for removing surface matter from a body of water and alluring game to the body of water, the decoy system comprising:
remote control signal transmitter means, the remote control transmitter means for transmitting user signals to remote control signal receiver means;
a buoyant decoy housing, the buoyant decoy housing for floating placement on a body of water, the body of water having a substantially planar water surface, the buoyant decoy housing further comprising a game-alluring upper portion and a hull-shaped lower portion, the game-alluring upper portion comprising an anterior portion and a posterior portion, the anterior portion and posterior portion each having game-simulative markings for alluring game, the game-alluring upper portion further comprising a removable cover, the removable cover for enabling entry into an interior decoy housing chamber, the interior decoy housing chamber for housing the remote control signal receiver means and a propulsion motor assembly, the remote control signal receiver means for receiving, decoding and directing signals from the remote control signal transmitter means, the remote control signal receiver means directing received, decoded signals to electro-mechanical apparatus responsive to received, decoded signals for selectively actuating the propulsion motor assembly for operatively driving the propulsion motor assembly, the hull-shaped lower portion further comprising propulsion means for propelling the buoyant decoy housing through the substantially planar water surface, the propulsion motor assembly capable of creating and transferring power to the propulsion means for operatively propelling and steering the buoyant decoy housing through the substantially planar water surface for alluring game; and
matter-removing means selected from the group consisting of matter-retrieving grapple means and ice-breaking means, the matter-retrieving grapple means for receiving and securely holding surface matter, the matter-retrieving grapple means being removably mounted to the anterior portion, the matter-retrieving grapple means thus enabling users to remove surface matter by remotely steering and propelling the buoyant decoy housing into surface matter, grappling the surface matter, and by further steering and propelling the buoyant decoy housing to the surface matter recipient for removing the surface matter, the ice-breaking means for breaking skim ice formed on the substantially planar water surface, the ice-breaking means being removably mounted to the anterior portion, thus enabling users to break through skim ice formed on the substantially planar water surface to create an ice-free water surface for alluring game to the body of water.
